(19) United States
(12) Patent Application Publication
(10) Pub. No.: US 2011/0261575 A1
(43) Pub. Date: Oct. 27, 2011

(54) TRUCK REAR LAMP

(76) Inventors: Hsi-Hsien Tsai, Tainan City (TW); Chih-Pin Shen, Kaohsiung City (TW)

(21) Appl. No.: 12/765,886

(22) Filed: Apr. 23, 2010

(51) Int. Cl. B60Q 1/30

(52) U.S. Cl. 362/485

(57) ABSTRACT

A truck rear lamp includes a base, a main lamp seat, a circuit board, a side lamp holder, a license plate lamp holder, a main lamp shell, a side lamp shell and a license plate lamp shell. The circuit board is assembled on the front side of the main lamp seat and provided thereon with plural main LEDs. The side lamp holder combined with a rear side of the main lamp seat is installed with plural side LEDs provided with no circuit board. The license plate lamp holder is set at a rear lower side of the main lamp seat and disposed with plural license plate LEDs provided with no circuit board and respectively having one side provided with a reflecting mirror for reflecting light of the license plate LEDs.

### BACKGROUND OF THE INVENTION

1. Field of the Invention

This invention relates to a truck rear lamp, particularly to one provided with a single circuit board in the interior of a main lamp seat for connecting different-function LEDs that are used for various ways of lighting and warning, able to economize materials of circuit boards and lower manufacturing cost.

2. Description of the Prior Art

A first conventional truck rear lamp disclosed in a U.S. Pat. No. 5,934,798 is only used for lighting a license plate but cannot serve as a stop lamp and a side marker lamp, and such a truck rear lamp needs to have a license plate lamp provided with a substratum that has the same function as a circuit board, impossible to save materials and lower cost. A second conventional truck rear lamp disclosed in a U.S. Pat. No. 6,533,445 B1 has LEDs and a circuit module connected to a first lamp shell and a second lamp shell. The first row of LEDs on the circuit module are juxtaposed on a tail lamp shell and connected with a first circuit board, and the second row of LEDs are juxtaposed on a side indicating lamp shell and connected to a second circuit board while the third row of LEDs are juxtaposed on a license plate lamp shell and connected to a third circuit board. The first, the second and the third circuit board are connected with a conductor and guided to the lamps mentioned above by means of an automobile cell system. However, in the structure of the second conventional truck rear lamp, the tail lamp shell, the side indicating lamp shell and the license plate lamp shell must be respectively provided with one circuit board and LEDs at corresponding locations for attaining different purposes of lighting and warning, thus increasing materials of circuit boards and enhancing manufacturing cost.

### SUMMARY OF THE INVENTION

The objective of this invention is to offer a truck rear lamp having a base provided therein with a single circuit board that is connected with LEDs with different functions for carrying out various ways of lighting and warning, able to save materials of circuit boards and lowering manufacturing cost.

The truck rear lamp in the present invention includes a base having its interior formed with a main accommodating chamber and one side provided with a side accommodating chamber that is bored with a side through hole communicating with the main accommodating chamber. The base further has its bottom disposed with a bottom through hole. A main lamp seat received in the main accommodating chamber of the base has its front side provided with a circuit board installed thereon with a plurality of main LEDs and has a rear side combined with a side indicating lamp holder installed with more than one side indicating LED connected to the circuit board of the main lamp seat by electric wires. The main lamp seat further has its rear side combined with a license plate lamp holder installed with one or more license plate LEDs connected to the circuit board of the main lamp seat by electric wires, and each license plate LED has one side disposed with a reflecting mirror for reflecting light of the license plate LEDs. A main lamp shell is mounted on the front side of the base, a side lamp shell is assembled at one side of the base and a license plate lamp shell is set on the bottom through hole of the base.

### BRIEF DESCRIPTION OF DRAWINGS

This invention will be better understood by referring to the accompanying drawings, wherein:

FIG. 1 is an exploded perspective view of a truck rear lamp in the present invention;

FIG. 2 is a perspective view of a side lamp holder in the present invention;

FIG. 3 is a perspective view of a license plate lamp holder in the present invention;

FIG. 4 is a perspective view of both the side lamp holder and the license plate lamp holder assembled at the rear side of a main lamp seat in the present invention;

FIG. 5 is a perspective view of the truck rear lamp in the present invention;

FIG. 6 is an upper cross-sectional view of the truck rear lamp in the present invention;

FIG. 7 is a side cross-sectional view of the truck rear lamp in the present invention; and

FIG. 8 is schematic view of the truck rear lamp installed on a truck for use in the present invention.

### DETAILED DESCRIPTION OF THE PREFERRED EMBODIMENT

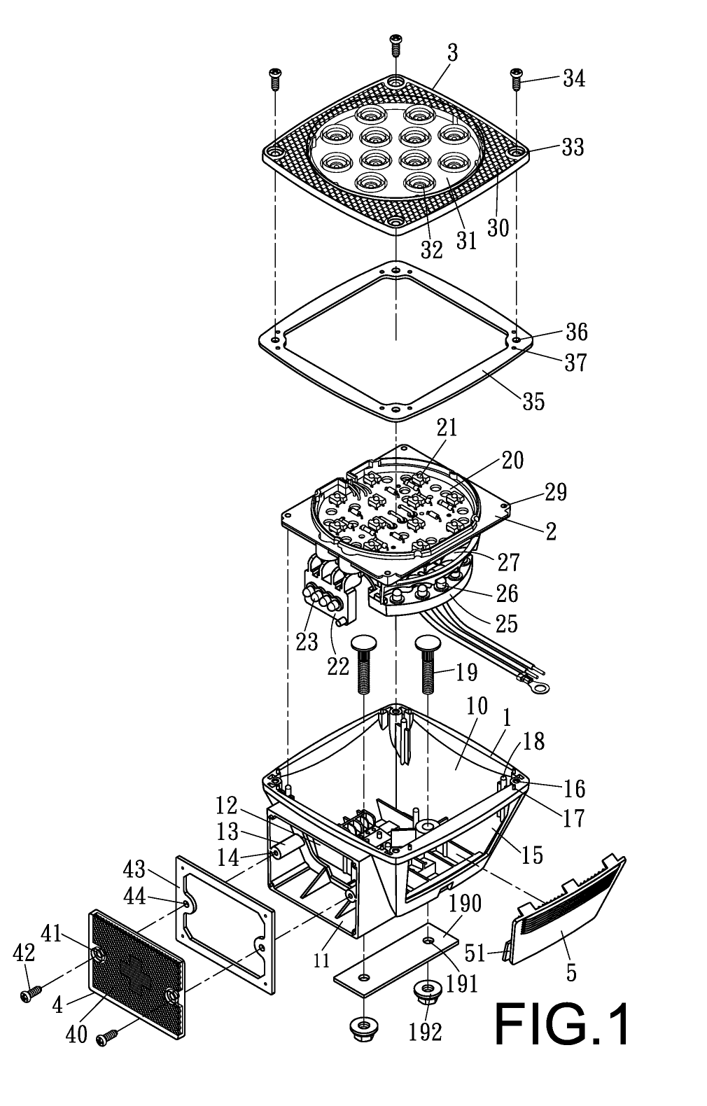

A preferred embodiment of a truck rear lamp in the present invention, as shown in FIGS. 1-4, includes a base 1, a main lamp seat 2, a main lamp shell 3, a side lamp shell 4 and a license plate lamp shell 5 as main components combined together.

The base 1 is formed with a main accommodating chamber 10 in the interior and has one side provided with a side accommodating chamber 11 bored with a side through hole 12 communicating with the main accommodating chamber 10 and disposed in the interior with a plurality of studs 13 respectively having a threaded hole 14. The base 1 is bored with a through hole 15 at the bottom, and has four corners of its front side respectively provided with a threaded hole 16 and two projections 17 and four corners of its inner side respectively fixed with a positioning stud 18. Two fixing bolts 19 are inserted through the rear side of the base 1, and then respectively inserted through two insert holes 191 of a gasket 190 and screwed with a nut 192.

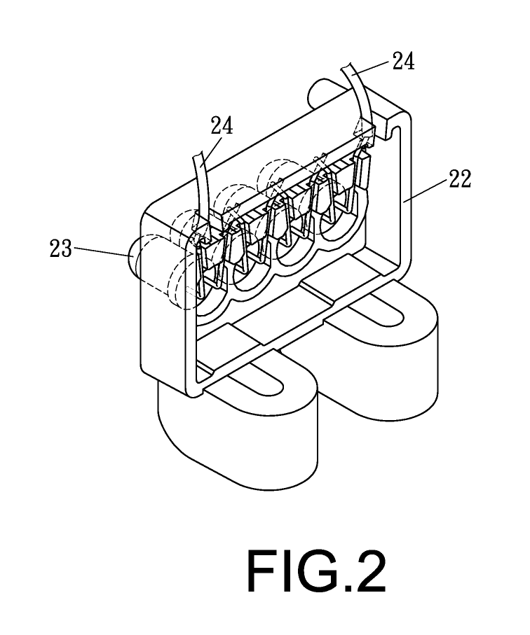

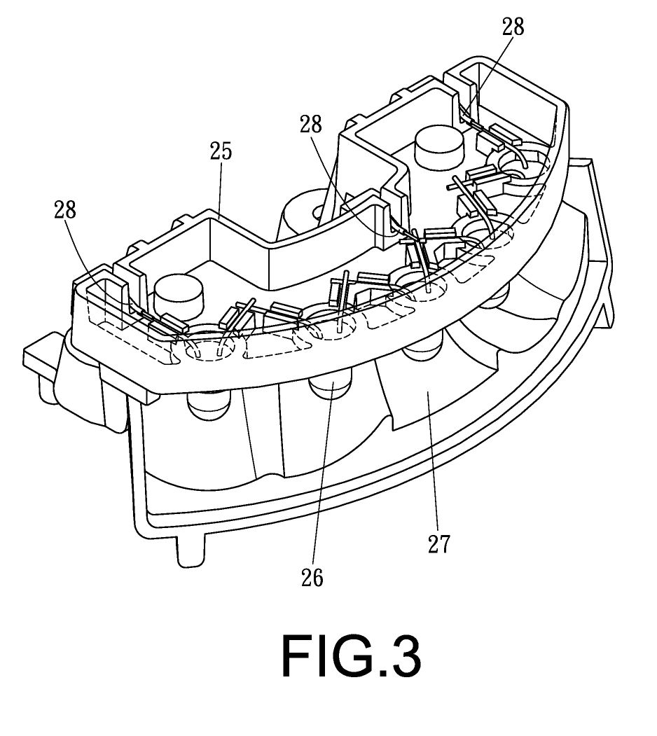

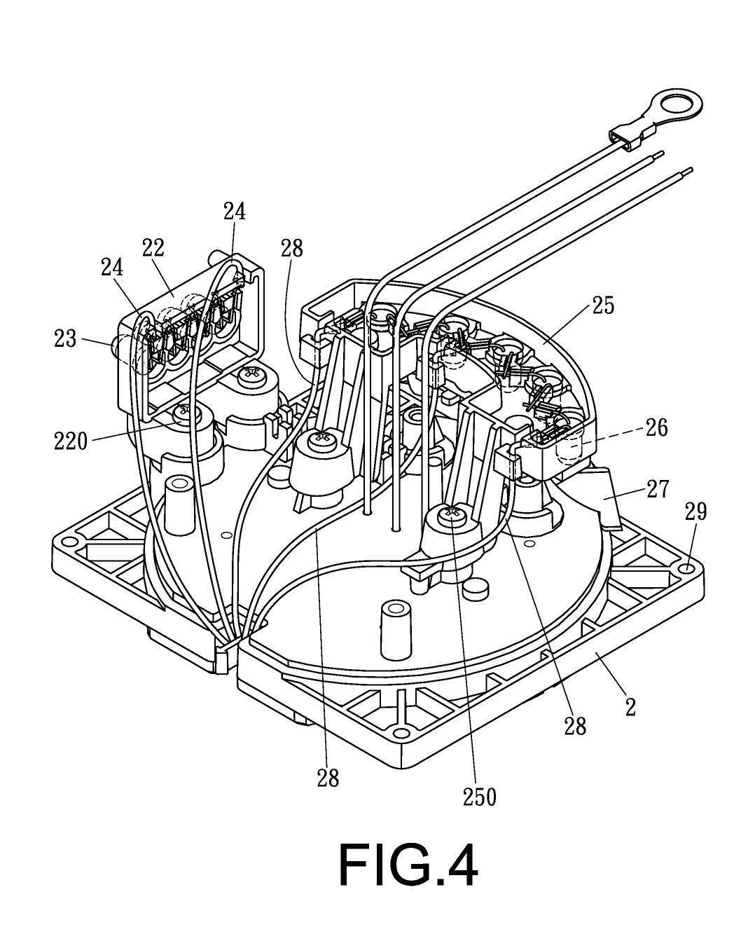

The main lamp seat 2 received in the main accommodating chamber 10 of the base 1 is provided therein with a circuit board 20 having its front side installed with a plurality of main LEDs 21 and its rear side combined with a side lamp holder 22, as shown in FIGS. 2 and 4. The side lamp holder 22 is secured at the rear side of the main lamp seat 2 by means of fixing members 220, having its outer side disposed with a plurality of side LEDs 23 that are connected to the circuit board 20 of the main lamp seat 2 by electric wires 24. A license plate lamp holder 25 is firmly assembled at a rear side of the main lamp seat 2 near the bottom by means of fixing members 250, as shown in FIGS. 3 and 4. The license plate lamp holder 25 has its outer side installed with a plurality of license plate LEDs 26 connected to the circuit board 20 of the main lamp seat 2 and respectively having one side provided with a reflecting mirror 27. The main lamp seat 2 further has four corners respectively bored with a positioning insert hole 29.

The main lamp shell 3 fixed on the front side of the base 1 is formed with a cubic reflecting surface 30 and formed inside with a circular lamp shell surface 31 having its inner side arranged with plural refracting patterns 32 at locations respectively corresponding with the main LEDs 21 on the circuit board 20. The main lamp shell 3 further has four corners respectively bored with an insert hole 33 inserted therein with a fixing member 34. A water-proof washer 35 is positioned between the main lamp shell 3 and the front side of the base 1, having four corners respectively bored with one insert hole 26 and two positioning engage holes 37.

The side lamp shell 4 assembled on the side accommodating chamber 11 of the base 2 has its inner side provided with a reflecting surface 40 and is oppositely bored with an insert hole 41 inserted therein with a fixing member 42. A water-proof washer 43 with two opposite insert holes 44 is fixed between the side accommodating chamber 11 and the side lamp shell 4.

The license plate lamp shell 5 is set on the bottom through hole 15 of the base 1, having two opposite sides respectively provided with a projecting engage member 51.

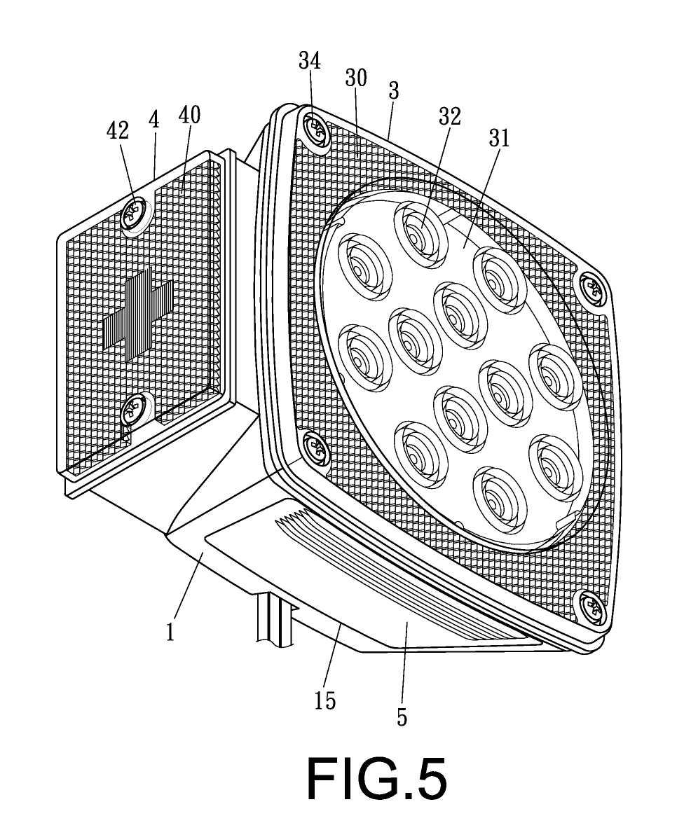

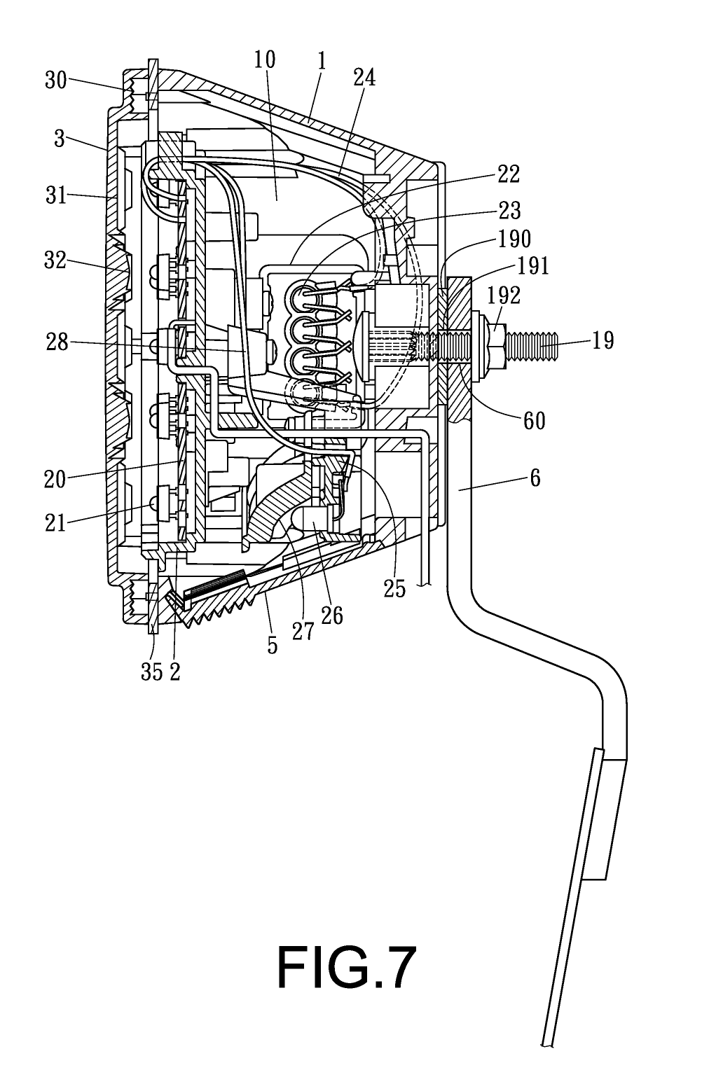

In assembling, referring to FIGS. 1-7, firstly, the side lamp holder 22 and the license plate lamp holder 25 are respectively secured on the rear side of the main lamp seat 2 by the fixing members 220 and 250, and the side LEDs 23 of the side lamp holder 22 and the license plate LEDs 26 of the license plate lamp holder 25 are respectively connected to the circuit board 20 of the main lamp seat 2 by means of the electric wires 24 and 28. Next, the main lamp seat 2 is received in the main accommodating chamber 10 of the base 2 to have the positioning studs 18 respectively inserted in the positioning insert holes 29 of the main lamp seat 2 for firmly positioning the main lamp seat 2 in the base 1 and have the side lamp holder 22 at one rear side of the main lamp seat 2 inserted through the side through hole 12 and positioned in the side accommodating chamber 11. Subsequently, the water-proof washer 35 is fixed on the base 1 to have the projections 17 on the base 1 respectively inserted in the positioning engage holes 37 of the water-proof washer 35 for fixing the water-proof washer 35 on the base 1, and then the main lamp shell 3 is firmly assembled on the base 1 by the fixing members 34 that are respectively inserted through the insert holes 33 of the main lamp shell 3 and the insert holes 36 of the water-proof washer 35 and then screwed in the threaded holes 16 of the base 1. Afterward, the side lamp shell 4 and the water-proof washer 42 are assembled on the outer wall of the side accommodating chamber 11 of the base 1 to position the water-proof washer 43 between the side lamp shell 4 and the side accommodating chamber 11 and then respectively insert the fixing members 42 through the insert holes 41 of the side lamp shell 4 and the insert holes 44 of the water-proof washer 43 and screwed in the threaded holes 14 of the side accommodating chamber 11 to secure the side lamp shell 4 on the side accommodating chamber 11 of the base 1. Lastly, the license plate lamp shell 5 is fixed in the bottom through hole 15 of the base 1 to have the engage members 51 of the license plate lamp shell 5 respectively engaged with the inner sides of the main accommodating chamber 10 of the base 1 to finish assembly of the truck rear lamp. To assemble a license plate 6 on the truck rear lamp, simply assemble the gasket 190 at the rear side of the base 1 and have the fixing bolts 19 respectively inserted through the insert holes 191 of the gasket 190 and the insert holes 60 of the license plate 6 and then screwed with nuts 192.

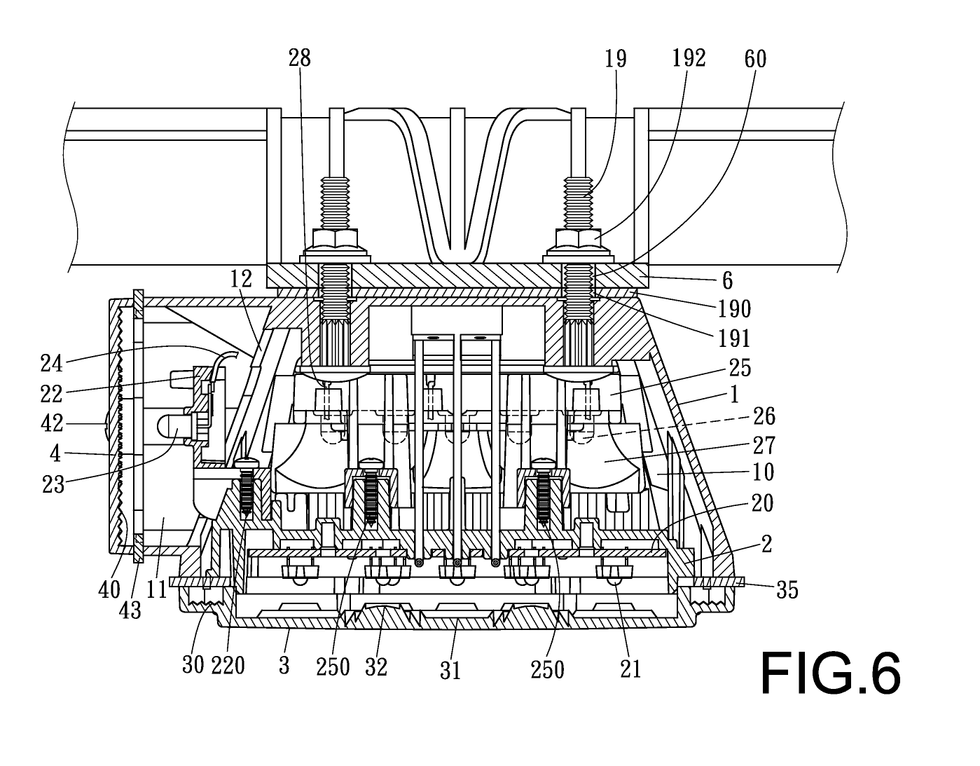

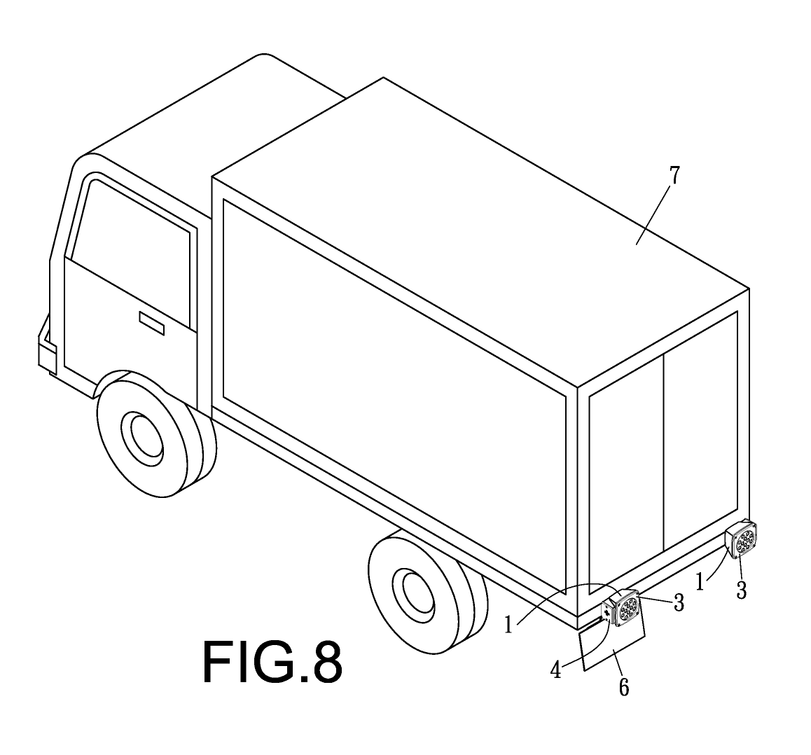

In using, referring to FIGS. 6, 7 and 8, the truck rear lamp assembled together with the license plates 6 is fixedly assembled at the opposite rear sides of a truck 7. When the lamps of the truck 7 are switched on, the main LEDs 21 on the circuit board 20 at the front side of the main lamp seat 2 will be controlled by the circuit board to shine and project light out through the main lamp shell 3 for warning vehicles coming from behind and simultaneously, the license plate LEDs 26 at the rear side of the main lamp seat 2 will be controlled by the circuit board 20 to shine and the light emitted by the license plate LEDs 26 will be reflected by the reflecting mirror 27 and projected out through the license plate 6. Meanwhile, the side LEDs 23 on the side lamp holder 22 at the rear side of the main lamp seat 2 will also be controlled by the circuit board 20 to shine and the light will be refracted out through the side lamp shell 4 for attaining effect of sideward warning.

Thus, the truck rear lamp of this invention can achieve various effects of lighting and warning by one single circuit board that is connected with LEDs with different functions, able to save materials of circuit boards and lower manufacturing cost.

While the preferred embodiment of the invention has been described above, it will be recognized and understood that various modifications may be made therein and the appended claims are intended to cover all such modifications that may fall within the spirit and scope of the invention.

What is claimed is:

1. A truck rear lamp comprising:
a base formed with a main accommodating chamber in an interior, said base having one side provided with a side accommodating chamber, said side accommodating chamber having a side through hole communicating with said main accommodating chamber, said base bored with a bottom through hole at a bottom;
a main lamp seat received in said main accommodating chamber of said base, said main lamp seat having a front side provided with a circuit board, said circuit board installed thereon with a plurality of main LEDs, said main lamp seat having a rear side combined with a side lamp holder, said side lamp holder installed with plural side LEDs, said side LEDs connected to said circuit board of said main lamp seat by electric wires, said main lamp holder having a rear side combined with a license plate lamp holder, said license plate lamp holder installed with plural license plate LED, said LED connected to said circuit board of said main lamp seat by electric wires, said license plate LEDs having one side provided with a reflecting mirror for reflecting light of said license plate LEDs;
a main lamp shell assembled on front side of said base;
a side lamp shell set at one side of said base; and
a license plate lamp shell positioned on said bottom through hole of said base.

2. A truck rear lamp as claimed in claim 1, wherein said base has four corners of a front side respectively bored with a threaded hole, and said main lamp shell has four corners respectively disposed with an insert hole inserted therein with a fixing member to be screwed in a threaded hole of said base.

3. A truck rear lamp as claimed in claim 1, wherein said side accommodating chamber of said base is oppositely bored with a threaded hole, and said side lamp shell is oppositely provided with an insert hole inserted therein with a fixing member to be screwed in a threaded hole of said side accommodating chamber.

4. A truck rear lamp as claimed in claim 1, wherein said base has two fixing bolts inserted through a rear side for firmly combining a license plate.

5. A truck rear lamp as claimed in claim 1, wherein said side lamp holder and said license plate lamp holder are firmly fixed on the rear side of said main lamp seat by means of fixing members.

6. A truck rear lamp as claimed in claim 1, wherein a water-proof washer is assembled between said main lamp shell and said base.

7. A truck rear lamp as claimed in claim 1, wherein a water-proof washer is mounted between said side lamp shell and said base.
